(19) United States
(12) Patent Application Publication
(10) Pub. No.: US 2007/0137342 A1
(43) Pub. Date: Jun. 21, 2007

(54) Gearing apparatus

(75) Inventor: Toru Hagihara, Kawaguchi-shi (JP)

Correspondence Address: MCDERMOTT WILL & EMERY LLP, 18191 VON KARMAN AVE., SUITE 500, IRVINE, CA, 92612-7108, US

(73) Assignee: Enplas Corporation, Kawaguchi-shi (JP)

(21) Appl. No.: 11/602,304

(22) Filed: Nov. 21, 2006

(30) Foreign Application Priority Data
Nov. 21, 2005 (JP) 2005-335200
Oct. 19, 2006 (JP) 2006-284925

(51) Int. Cl. F16H 1/12; F16H 1/14; F16H 1/20

(52) U.S. Cl. 74/416; 74/417

(57) ABSTRACT

A gearing apparatus having a driving gear G₀ of a predetermined tooth width, and secured to an input shaft having an axis thereof, a first small diameter driven gear G₁ formed of a face gear secured to an end of an output shaft having an axis thereof perpendicularly intersecting with the axis of the input shaft and engaged with the driving gear at a portion within the tooth width of the driving gear; and a second large diameter driven gear G₂ formed of a face gear secured to an end portion of another output shaft having an axis thereof perpendicularly intersecting with the axis of the input shaft and engaged with the driving gear at a remaining portion within the tooth width. The output shafts are coaxial and are extended in opposite directions, and the rotation of the driven gears G₁ and G₂ according to the rotation of the driving gear G₀ are mutually opposite.

### BACKGROUND OF THE INVENTION

1. Field of the Invention

The present invention relates to a gearing apparatus for transmitting a rotational driving force from one input axis to output axes orthogonal to the input axis through engagement of a driving gear with driven gears in a gearbox and the like incorporated in, for example, a drive apparatus and like and more particularly, to a gearing apparatus capable of deriving outputs about respective axes of two output shafts which are arranged to be opposite to each other and also are orthogonal to an input axis of one input shaft, so that the two output shafts are driven to rotate in opposite directions to each other and also in different numbers of rotations, and further capable of decreasing the number of components of the gearing apparatus.

2. Description of the Related Art

Japanese Unexamined Patent Publication No. 58-196348 (JP-A-58-196348) discloses a typical example of a conventional gearing apparatus of this type, in which a pair of face gears is mounted on an output shaft having an axis thereof positioned in a direction orthogonal to an axis of an input shaft of the gearing apparatus. The pair of face gears of the gearing apparatus is supported on the output shaft in a loose-fitting manner while coaxially opposing to each other along the axis of the output shaft. Each of the opposing face gears has such a tooth profile that outer and inner face gear teeth are concentrically formed about the axis thereof. The outer face gear teeth of the respective face gears have different numbers of teeth to be engaged with an opinion arranged on the input shaft while the inner face gear teeth of respective of the opposing face gears have the same number of teeth. The output shaft of the gearing apparatus has a support portion thereof disposed between the pair of loose-fitted and opposing face gears, so that a planet spur gear is rotatably supported on a pivotal shaft which is supported by and intersects with the support portion of the output shaft, and that the planet spur gear is engaged with the inner face gear teeth of both of the opposing face gears (specifically refer to FIG. 1 of JP-A-58-196348).

However, the gearing apparatus disclosed in JP-A-58-196348 is an epicyclic reduction gear in which a single output shaft is provided relative to the input shaft and also the reducing ratio is set to have a fixed singular reduction ratio. Accordingly, such a conventional epicyclic reduction gear is not provided with such a configuration that two separate output shafts having respective axes opposite to each other are arranged to be orthogonal to the axis of an input shaft, to thereby rotate two separate output shafts in opposite directions to each other and also in the different numbers of revolutions.

Here, referring to FIG. 8, there is illustrated an exemplary gearing apparatus for deriving two rotational outputs about two separate output shafts having respective axes which are arranged to be opposite to each other and also are orthogonal to an axis of a single input shaft, to rotate the two output shafts in opposite directions to each other. In this gearing apparatus, there can be considered to have such a configuration that a driving gear Ga comprised of a straight bevel gear which is attached to a extreme end portion of an input shaft 1; a first driven gear Gb comprised of a straight bevel gear which is attached to a base end portion of an output shaft 2a intersecting at right angle with the input shaft 1 of the driving gear Ga, to be engaged with the driving gear Ga; and a second driven gear Gc comprised of a straight bevel gear which is attached to a based end portion of another output shaft 2b intersecting at right angle with the input shaft 1 of the driving gear Ga, to be engaged with the driving gear Ga are incorporated so as to cooperate with one another to eventually produce two rotational outputs about the output shafts 2a and 2b.

However, even in this case, although it is possible to arrange the two separate output shafts 2a and 2b which are opposite to each other and also are orthogonal to the single input shaft 1 to rotate the two output shafts in opposite directions to each other, it is impossible to rotate the two output shafts 2a and 2b at respective rotating numbers different from one another. Consequently, such a gearing apparatus cannot be applied to a gearbox and the like which is required to rotate the two output shafts 2a and 2b in the different rotating numbers.

In order to cope with the above-mentioned problem to thereby rotate the two output shafts 2a and 2b in the different rotating numbers, there might have been proposed another exemplary gearing apparatus as illustrated in FIG. 9, in which a second additional driving gear Gd having a diameter different from that of the first driving gear Ga is mounted on the input shaft 1, and the first driven gear Gb and the second driven gear Gc are formed to have different diameters from each other thereby having different numbers of teeth, so that the first driving gear Ga and the first driven gear Gb are engaged with each other, and the second driving gear Gd and the second driven gear Gc are engaged with each other.

Nevertheless, in the gearing apparatus of FIG. 9, it is possible to rotate the two output shafts 2a and 2b in the different numbers of revolutions, but for this purpose, the second driving gear Gd must be provided in addition to the first driving gear Ga, resulting in an increase in the number of gear components and in a complicated structure of the gearing apparatus. Further, since the second driving gear Gd is necessary for being provided and also the diameter of, for example, the second driven gear Gc must be increased, the overall gearing apparatus must necessarily be large in its size.

### SUMMARY OF THE INVENTION

In view of the above problems, the present invention has an object to provide a gearing apparatus capable of deriving two output shafts which are arranged to be opposite to each other and also arranged to be orthogonal to a single input shaft, in order to rotate the two output shafts in opposite directions to each other and also in the different numbers of rotations, and further capable of decreasing the number of structural components to be incorporated therein.

To achieve the above object, in accordance with the present invention, there is provided a gearing apparatus which comprises: a driving gear having a predetermined tooth width, which is secured to a frontmost end portion of an input shaft having a rotating axis thereof; a first driven gear of small diameter including a face gear which is secured to a base end portion of an output shaft having a rotating axis thereof intersecting at right angle with the rotating axis of the input shaft of the driving gear, and is engaged with the driving gear within the predetermined tooth width of the driving gear; and a second driven gear of large diameter including a face gear which is secured to a base end portion of another output shaft having a rotating axis thereof intersecting at right angle with the rotating axis of the input shaft of the driving gear, and is engaged with the driving gear within the predetermined tooth width of the driving gear, wherein the output shafts of the first and second driven gears are coaxially arranged but extended in opposite directions to one another, and both the first and second driven gears on the one and another output shafts are rotated in opposite directions to each other according to a rotation of the driving gear on the input shaft.

According to the above configuration, the one and another output shafts are coaxially arranged to be extended in opposite directions to each other, and the first driven gear of small diameter including the face gear which is engaged with the driving gear within the tooth width of the driving gear and the second driven gear of large diameter including the face gear which is engaged with the driving gear within the tooth width of the driving gear, are rotated in opposite directions to each other according to the rotation of the driving gear having the predetermined tooth width, which is attached to the tip end portion of the input shaft. Accordingly, only by combining the driving gear with the first and second driven gears, it is possible to derive the two output shafts which are coaxially arranged to be extended in opposite directions to each other and also are orthogonal to the single input shaft, and to rotate the two output shafts in opposite directions and also in the different numbers of rotations, thereby transmitting a driving force. Further, since the number of the driving gears may be only one, it is possible to decrease the number of structural components so as to simplify an entire structure of the gearing apparatus. Furthermore, it is possible to prevent an increase in the size of the gearing apparatus.

Further, the driving gear may be formed of a spur gear, and the first and second driven gears, each including a disc-like face gear engaged with the driving side spur gear. As a result, the gearing apparatus can be configured by employment of simple face gears having a plurality of straight teeth engageable with the spur gear of the driving gear.

Furthermore, the driving gear may be formed of a helical gear, and the first and second driven gears, each including a disc-like face gear engaged with the driving side helical gear. As a result, the gearing apparatus can be configured by employment of face gears having a plurality of helical teeth engageable with the helical gear of the driving gear.

Still further, a reduction ratio by the engagement of the driving gear with the first driven gear and a reduction ratio by the engagement of the driving gear with the second driven gear are set to be different from each other. As a result, it is possible to allow the reduction ratios of the first and second output shafts coaxially arranged to be extended in opposite directions and rotated in opposite directions to differ from each other. Accordingly, in the gearing apparatus configured to derive the two output shafts which are extended in opposite directions to each other and also are orthogonal to the single input shaft, so as to rotate the two output shafts in opposite directions to each other, it is possible to change rotating speeds of the two output shafts between respective output shafts, thereby transmitting a rotational driving force to every output shaft.

Still further, the driving gear may be divided into two gear-teeth-regions within the tooth width thereof and each of the divided gear-teeth-regions may have different number of teeth. As a result, it is possible to change the reducing ratios of the output shafts which are coaxially arranged to be extended in opposite directions and rotated in opposite directions to each other, by allowing the numbers of gear teeth of the respective gear-teeth-regions within the tooth width to be different from each other in the driving gear with which the first and second driven gears are engaged respectively. Consequently, it is possible to further adjustably finely change the rotating speeds of the two output shafts for every output shaft, in the gearing apparatus that derives the two output shafts coaxially arranged to be extended in the opposite directions and also to be orthogonal to the single input shaft, so as to rotate the two output shafts in the opposite directions to each other.

Moreover, the single driving gear may be constructed to have two teeth regions divided within the tooth width thereof, and to have two different diameters in the respective divided regions from each other, so as to form a large diameter portion and a small diameter portion. Also, each of the large and small diameter portions may have different number of teeth, so that the first driven gear is engaged with one of the large and small diameter portions of the driving gear and the second driven gear is engaged with the other of the large and small diameter portions thereof. As a result, it is possible to change the reducing ratios of the output shafts which are coaxially arranged to be extended in opposite directions and are rotated in opposite directions to each other, by allowing the diameters of the two respective teeth regions within the tooth width and the numbers of teeth thereof to be different from each other in the driving gear with which the first driven gear and the second driven gear are engaged respectively. Consequently, it is possible to further adjustably finely change the rotating speeds of the two output shafts for every output shaft in the gearing apparatus that derives the two output shafts which are arranged to be extended in opposite directions and also are orthogonal to the single input shaft, so as to rotate the two output shafts in the mutually opposite directions, whereby the range of change in the reduction ratios of the two output shafts may be broadened.

The other objects, features and advantages of the present invention will become more understandable from the ensuing description with reference to the accompanying drawings.

### BRIEF DESCRIPTION OF THE DRAWINGS

FIG. 1 is a schematic diagram showing a first embodiment of a gearing apparatus according to the present invention;

FIG. 2 is a bottom view showing a disc shape of a first driven gear;

FIG. 3 is a plan view showing a disc shape of a second driven gear;

FIG. 4 is a perspective view showing an engagement state of a driving gear consisting of a spur gear with the second driven gear;

FIG. 5 is a perspective view showing a second embodiment of the gearing apparatus according to the present invention, which shows an engagement state of the driving gear consisting of a helical gear with the second driven gear;

FIG. 6 is a schematic diagram showing a third embodiment of the gearing apparatus according to the present invention;

FIG. 7 is a schematic diagram showing a fourth embodiment of the gearing apparatus according to the present invention;

FIG. 8 is a schematic diagram showing a configuration which can be considered as a gearing apparatus for taking out two output shafts which are opposite to each other and also are orthogonal to one input shaft, to rotate the two output shafts in opposite directions to each other; and,

FIG. 9 is a schematic diagram showing a configuration which can be considered as a gearing apparatus for taking out two output shafts which are opposite to each other and also are orthogonal to one input shaft, to rotate the two output shafts in opposite directions to each other and also in the different numbers of revolutions.

### DESCRIPTION OF PREFERRED EMBODIMENTS OF THE INVENTION

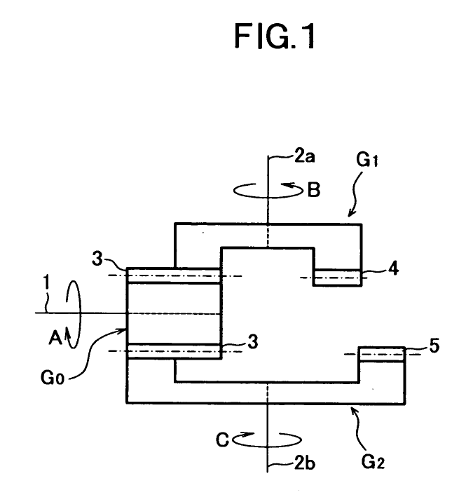

There will be described hereunder several preferred embodiments of the present invention based on the accompanying drawings. FIG. 1 is a schematic diagram showing a first embodiment of a gearing apparatus according to the present invention. This gearing apparatus is configured to derive different output shafts but arranged to be orthogonal to an input shaft to transmit a driving force to the output shafts via engagement of a driving gear with driven gears in a gearbox and the like for a drive apparatus and the like for example, and is comprised of a driving-gear G₀, a first driven gear G₁ and a second driven gear G₂. The driving force transmitted to each of the output shafts is exhibited toward outside the gearing apparatus.

The driving gear G₀ is provided for supplying the gearing apparatus with an input rotational driving force, and comprised of a spur gear which is secured to a frontmost end portion of an input shaft 1 coupled to a drive source such as a motor (not shown in the figure) and has a predetermined tooth width intended to be wider in an axial direction than tooth width of a normal spur gear. Note: the reference numeral 3 designates a plurality of teeth formed on an outer circumferential surface of the driving gear G₀.

With a portion of the teeth 3 within the tooth width of the driving gear G₀, the first driven gear G₁ is engaged. This first driven gear G₁ is provided for receiving a rotational driving force from the driving gear G₀ to transmit the rotation thereof to an output shaft 2a, and comprised of a face gear which is secured to a base end portion of the output shaft 2a having an axis thereof intersecting at right angle with an axis of the input shaft 1 of the driving gear G₀ and is engaged with the portion of the teeth within the tooth width of the teeth 3 of the driving gear G₀. Note: the reference numeral 4 designates a plurality of teeth formed on an outer peripheral surface of the first driven gear G₁. Each of the plurality of teeth 4 has the shape of a straight gear tooth engageable with the spur gear of the driving gear G₀.

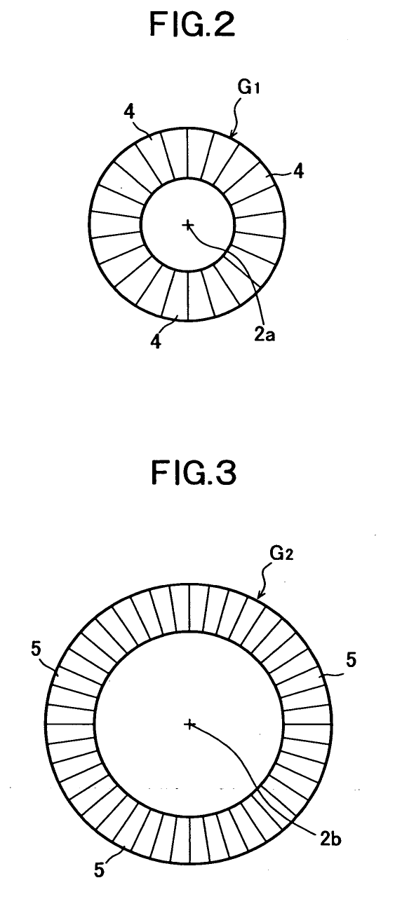

The first driven gear G₁ is a gear engaged with the driving gear G₀ comprised of the spur gear, and therefore, is formed in a disc shape as shown in FIG. 2 in which a plurality of radially arranged teeth 4 is formed in a lower annular surface of the outer periphery thereof, and further, a diameter thereof is smaller than a diameter of the second driven gear G₂ to be described later.

With the remaining portion of the teeth 3 within the tooth width of the driving gear G₀, the second driven gear G₂ is engaged. This second driven gear G₂ is provided for receiving the rotational driving force from the driving gear G₀ to transmit the rotation thereof to another output shaft 2b, and comprised of a face gear which is secured to a base end portion of the output shaft 2b having an axis intersecting at right angle with the axis of the input shaft 1 of the driving gear G₀ and is engaged with the remaining portion of the teeth within the tooth width of the teeth 3 of the driving gear G₀. Note: the reference numeral 5 designates a plurality of teeth formed in an annular surface of an outer periphery of the second driven gear G₂. Each of the plurality of teeth 5 has the shape of a straight gear engageable with the spur gear of the driving gear G₀.

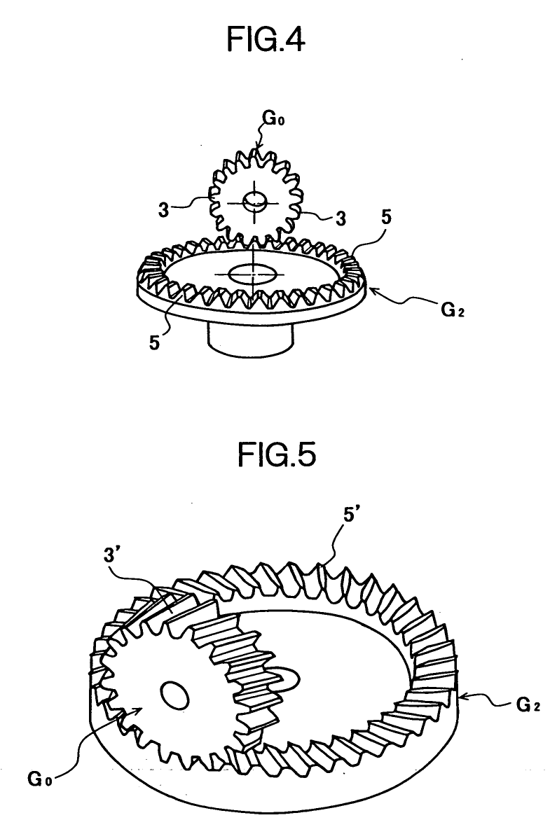

The second driven gear G₂ is a gear engaged with the driving gear G₀ comprised of the spur gear, and therefore, is formed in the shape of a disc as shown in FIG. 3, in which the plurality of radially arranged teeth 5 is formed on an upper surface of the outer periphery thereof, and further, a diameter thereof is larger than the diameter of the first driven gear G₁. Incidentally, FIG. 4 is a perspective view showing a state of engagement of the driving gear G₀ comprised of the spur gear with the second driven gear G₂. At this stage, in FIG. 4, for the sake of simplicity of the drawing figure, the first driven gear G₁ is omitted. Further, similarly to FIG. 1, the tooth width the driving gear G₀ is only of the width appropriate for allowing the driving gear G₀ to be engaged with both the first driven gear G₁ and the second driven gear G₂.

Then, in FIG. 1, the output shafts 2a and 2b of the first and second driven gears G₁ and G₂ are coaxially arranged to be extended in opposite directions to each other, and both of the driven gears G₁ and G₂ are rotated in opposite directions to each other, indicated by arrow B and C, according to the rotation of the driving gear G₀ in a direction indicated by an arrow A. In this case, it is to be noted that the single driving gear G₀ is provided for being commonly engaged with both the first and second driven gears G₁ and G₂ to drive these driven gears G₁ and G₂, and therefore, the number of structural components can be decreased resulting in a simple structure of the gearing apparatus. Further, it is possible to prevent that the overall gearing apparatus grows in size.

In the configuration as described in the above, the number of teeth in the teeth 3 of the driving gear G₀ is in one type (for example, N), and the number of teeth in the teeth 4 of the first driven gear G₁ and the number of teeth in the teeth 5 of the second driven gear G₂ are different from each other (for example N₁ or N₂), since the gear diameters thereof are different from each other. Further, a reduction ratio due to the engagement of the driving gear G₀ with the first driven gear G₁ and a reduction ratio due to the engagement of the driving gear G₀ with the second driven gear G₂ are changed from each other.

Namely, the reduction ratio R₁ due to the engagement of the driving gear G₀ with the first driven gear G₁ is;
R₁=N/N₁ (1), and
the reduction ratio R₂ due to the engagement of the driving gear G₀ with the second driven gear G₂ is;
R₂=N/N₂ (2).

FIG. 5 is a perspective view showing a gearing apparatus according to a second embodiment of the present invention. In this embodiment, the driving gear G₀ comprised of a helical gear, and the first and second driven gears G₁ and G₂, each comprised of a disc shape face gear to be engaged with the helical gear of the driving gear G₀. As will be understood from FIG. 5 showing a state of engagement of the driving gear G₀ comprised of the helical gear with the second driven gear G₂, a plurality of teeth (helical teeth) designated by reference numeral 3′ is formed in the outer circumferential surface of the driving gear G₀, and a plurality of helically extending teeth designated by reference numeral 5′ is formed in the outer peripheral surface of the second driven gear G₂. The configuration of the second embodiment other than the above is similar to that of the first embodiment shown in FIG. 1. Here, for the sake of simplicity of the drawing figure, the first driven gear G₁ is omitted. Further, similarly to FIG. 1, the tooth width of the driving gear G₀ comprised of the helical gear is only of the width enough for allowing the first driven gear G₁ to be engaged with the second driven gear G₂.

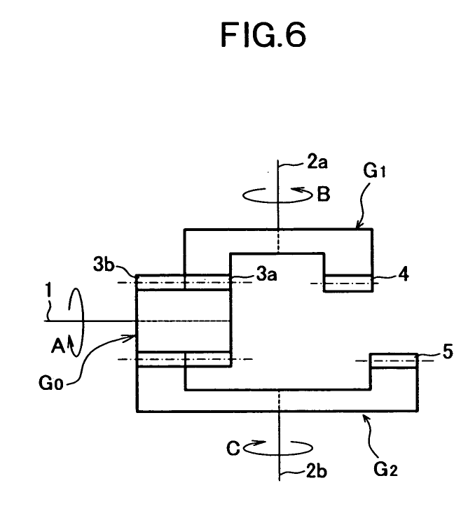

FIG. 6 is a schematic diagram showing a gearing apparatus according to a third embodiment of the present invention. In this embodiment, the driving gear G₀ is provided in the circumference thereof with gear teeth arranged in two separate regions axially divided within the tooth width thereof, so that each of the separate regions has the different number of teeth. Namely, the tooth width of the driving gear G₀ is formed to be divided at, for example, a center portion thereof into regions 3a and 3b in which the number of teeth provided in the tooth width region 3a is Na and the number of teeth provided in the tooth width region 3b is Nb. Then, the tooth width region 3a of the driving gear G₀ is engaged with the first driven gear G₁, while the tooth width region 3b being engaged with the second driven gear G₂.

In this state, the number of teeth in the teeth 3 of the driving gear G₀ is in two types of Na and Nb, and if the number of teeth in the teeth 4 of the first driven gear G₁ to be engaged with the tooth width region 3a of the driving gear G₀ is N₁ₐ and the number of teeth in the teeth 5 of the second driven gear G₂ to be engaged with the tooth width region 3b of the driving gear G₀ is N_{2b}, a reduction ratio due to the engagement of the driving gear G₀ with the first driven gear G₁ and a reduction ratio due to the engagement of the driving gear G₀ with the second driven gear G₂ are represented in the followings.

The reduction ratio R₁ due to the engagement of the tooth width region 3a of the driving gear G₀ with the first driven gear G₁ is;
R₁=Na/N₁ₐ (3), and
the reduction ratio R₂ due to the engagement of the tooth width region 3b of the driving gear G₀ with the second driven gear G₂ is;
R₂=Nb/N_{2b} (4).

The reduction ratios shown in the above equations (3) and (4) can be adjusted more finely than the reduction ratios shown in the equations (1) and (2), by appropriately selecting the number of teeth Na in the tooth width region 3a of the driving gear G₀ and the number of teeth Nb in the tooth width region 3b thereof.

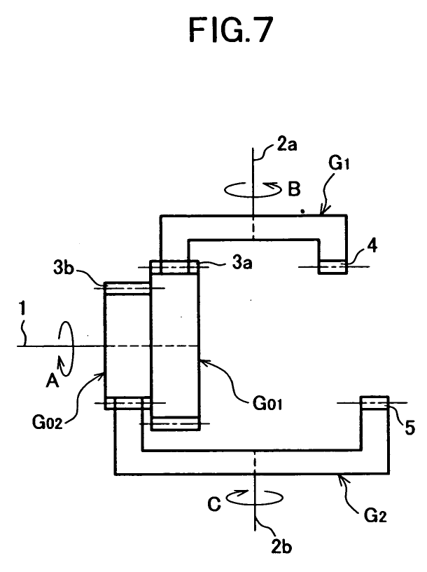

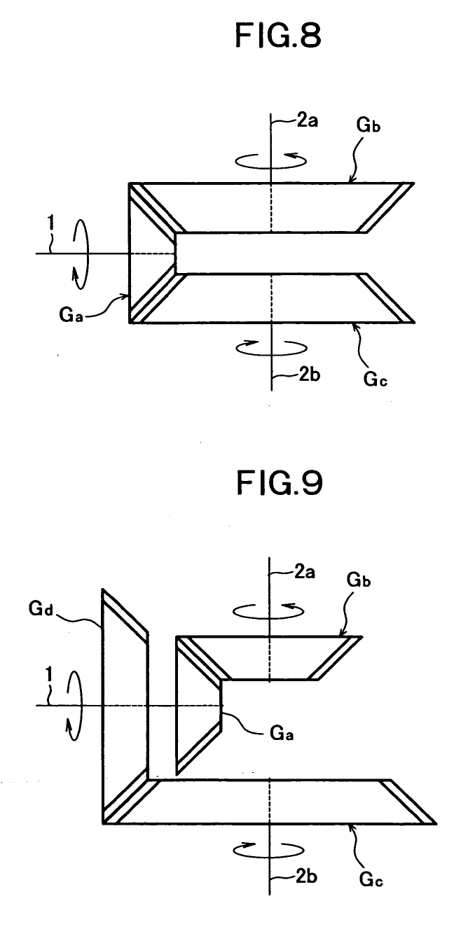

FIG. 7 is a schematic diagram showing a gearing apparatus according to a fourth embodiment of the present invention. In this embodiment, the driving gear G₀ is formed to have two separate regions within the tooth width thereof, so that diametrical dimensions of the respective separate regions are designed so as to be different from each other thereby forming a large diameter portion G₀₁ and a small diameter portion G₀₂, and also, the large diameter portion G₀₁, and the small diameter portion G₀₂ have a plurality of teeth on the circumferences thereof, respectively, which are different in the number from each other. Namely, the entire tooth width of the driving gear G₀ is separated at, for example, the center portion thereof into two regions 3a and 3b, so that the tooth width region 3a is made to be a large diameter portion G₀₁, the tooth width region 3b is made to be a small diameter portion G₀₂, the number of teeth in the large diameter portion G₀₁ is set to be Nc and the number of teeth in the small diameter portion G₀₂ is set to be Nd. Then, the large diameter portion G₀₁ of the driving gear G₀ is engaged with the first driven gear G₁ and the small diameter portion G₀₂ thereof is engaged with the second driven gear G₂.

In this state, the number of teeth of the driving gear G₀ is in two types of Nc in the large diameter portion G₀₁ and Nd in the small diameter portion G₀₂, and if the number of teeth in the teeth 4 of the first driven gear G₁, to be engaged with the large diameter portion G₀₁ of the driving gear G₀ is N_{1c} and the number of teeth in the teeth 5 of the second driven gear G₂ to be engaged with the small diameter portion G₀₂ of the driving gear G₀ is N_{2d}, a reduction ratio due to the engagement of the large diameter portion G₀₁ of the driving gear G₀ with the first driven gear G₁and a reduction ratio due to the engagement of the small diameter portion G₀₂ of the driving gear G₀ with the second driven gear G₂ are represented in the followings.

The reduction ratio R₁ due to the engagement of the large diameter portion G₀₁ of the driving gear G₀ with the first driven gear G₁ is;
R₁=Nc/N_{1c} (5), and
the reduction ratio R₂ due to the engagement of the small diameter portion G₀₂ of the driving gear G₀ with the second driven gear G₂ is;
R₂=Nd/N_{2d} (6).

The reduction ratios indicated by the above equations (5) and (6) can be further adjusted more finely than the reduction ratios indicated by the equations (1) and (2) and the equations (3) and (4), by appropriately selecting the number of teeth Nc in the large diameter portion G₀₁ of the driving gear G₀ and the number of teeth Nd in the small diameter portion G₀₂ thereof, thereby enabling broadening the range of the reduction ratio.

Incidentally, in FIG. 7, the configuration is such that the tooth width region 3a of the driving gear G₀ is made to be the large diameter portion G₀₁ and the tooth width region 3b thereof is made to be the small diameter portion G₀₂. However, the present invention is not limited thereto, and the tooth width region 3a may be made to be the small diameter portion G₀₂ and the tooth width region 3b may be made to be the large diameter portion G₀₁.

It should be appreciated that many changes and modifications will occur to a person skilled in the art without departing from the spirit and scope of the invention as claimed in the accompanying claims. Further, it should be appreciated that the entire contents of Japanese Patent Application Nos. 2005-335200 and 2006-284925, filed on Nov. 21, 2005 and Oct. 19, 2006 are incorporated herein by reference.

I (We) claim:

1. A gearing apparatus comprising:
a driving gear secured to a frontmost end portion of an input shaft and having a predetermined tooth width;
a first driven gear of small diameter including a face gear secured to a base end portion of an output shaft having an axis thereof intersecting at right angle with an axis of the input shaft securing thereto said driving gear, to be engaged with said driving gear within the predetermined tooth width of said driving gear; and
a second driven gear of large diameter including a face gear secured to a base end portion of another output shaft having an axis thereof intersecting at right angle with the axis of the input shaft of said driving gear, to be engaged with said driving gear within the predetermined tooth width of said driving gear,
wherein the output shafts securing thereto said first and second driven gears, respectively, are coaxially arranged to be extended in opposite directions to each other, and both of said driven gears are rotated in opposite directions to each other according to a rotation of said driving gear.

2. The gearing apparatus according to claim 1, wherein said driving gear comprises a spur gear, and
wherein each of said first and second driven gears comprises a disc face gear engageable with said driving side spur gear.

3. The gearing apparatus according to claim 1, wherein said driving gear comprises a helical gear, and
wherein each of said first and second driven gears comprises a disc face gear engageable with said driving side helical gear.

4. The gearing apparatus according to claim 1, -wherein -a reduction ratio due to engagement of said driving gear with said first driven gear and a reduction ratio due to engagement of said driving gear with said second driven gear are set to be different from each other.

5. The gearing apparatus according to claim 1, wherein said driving gear is provided with two separate regions divided within the predetermined tooth width thereof, each of the two regions having teeth formed therein so that numbers of the teeth of said two regions are different from each other.

6. The gearing apparatus according to claim 1, wherein said driving gear is provided with two separate regions divided within the predetermined tooth width thereof, said respective separate regions of said driving gear being formed to have diameters different from each other, thereby forming a large and a small two diameter portions,
wherein the two large and small diameter portions have a plurality of teeth formed therein, respectively, so that a number of the teeth of one of the two diameter portions is different from that of the teeth of the other of the two diameter portions, and,
wherein said first driven gear is engaged with one of the two large and small diameter portions of said driving gear and said second driven gear is engaged with the other of the two large and small diameter portions of said driving gear.
